(19) United States
(12) Patent Application Publication
(10) Pub. No.: US 2008/0276522 A1
(43) Pub. Date: Nov. 13, 2008

(54) Bobber

(75) Inventor: Warren Edward Roh, Monument, CO (US)

Correspondence Address: LAW OFFICE OF DALE B. HALLING, LLC, 655 SOUTHPOINTE CT, SUITE 100, COLORADO SPRINGS, CO, 80906, US

(73) Assignee: Practical Products, Inc.

(21) Appl. No.: 12/080,722

(22) Filed: Apr. 4, 2008

Related U.S. Application Data
(60) Provisional application No. 60/921,782, filed on Apr. 4, 2007.

(51) Int. Cl. A01K 93/00

(52) U.S. Cl. 43/43.13

(57) ABSTRACT

A bobber has a float and sail. The sail catches the wind and stealthily moves the bait over to the area where the fish are, such as under the overhanging trees or branches near the shore of a lake. The sail also makes the bobber more aerodynamic and allows for more accurate casting. The sail may be attached to a stem that is attached to the float. The sail may be removable from the stem. This allows the fisherman to put on larger or smaller sails and also directional sails. The stem and/or the float may have a passage way so that the bobber can be used a slip bobber or a fixed bobber.

### RELATED APPLICATIONS

The present invention claims priority on provisional patent application Ser. No. 60/921,782, filed on Apr. 4, 2007, entitled “Sail for a float” and is hereby incorporated by reference.

### STATEMENT REGARDING FEDERALLY SPONSORED RESEARCH

Not Applicable

### THE NAMES OF THE PARTIES TO A JOINT RESEARCH AGREEMENT

Not Applicable

### REFERENCE TO A SEQUENCE LISTING, A TABLE, OR A COMPUTER PROGRAM LISTING

Not Applicable

### BACKGROUND OF THE INVENTION

Recreational fisherman use bobbers to alert them to a strike on their fish line. One of the problems with using a bobber is that it makes a big splash when cast and this scares the fish away. In addition, bobbers are often difficult to cast to the desired spot due to their non-aerodynamic shape. One place the fish often group is under trees and other overhangs near the shore. The problem of casting to these spots is made even more difficult with a bobber on the line.

Thus there is a need for a bobber that is more aerodynamic and does not scare away the fish.

### BRIEF SUMMARY OF INVENTION

A bobber that overcomes these and other problems includes a float and a sail. The sail catches the wind and stealthily moves the bait over to the area where the fish are, such as under the overhanging trees or branches near the shore of a lake. The sail also makes the bobber more aerodynamic and allows for more accurate casting. The sail may be attached to a stem that is attached to the float. The sail may be removable from the stem. This allows the fisherman to put on larger or smaller sails and also directional sails. The stem and/or the float may have a passage way so that the bobber can be used a slip bobber or a fixed bobber.

### BRIEF DESCRIPTION OF THE SEVERAL VIEWS OF THE DRAWINGS

FIG. 1 is a diagram of a fisherman using a bobber in accordance with one embodiment of the invention;

FIG. 2 is a perspective view of a bobber in accordance with one embodiment of the invention;

FIG. 3 is a top view of a bobber in accordance with one embodiment of the invention;

FIG. 4A is a perspective view of a sail in accordance with one embodiment of the invention;

FIG. 4B is a diagrammatic view of how the sail of FIG. 4A reacts to wind;

FIG. 5A is a perspective view of a sail in accordance with one embodiment of the invention;

FIG. 5B is a diagrammatic view of how the sail of FIG. 5A reacts to wind;

FIG. 6A is a perspective view of a sail in accordance with one embodiment of the invention;

FIG. 6B is a diagrammatic view of how the sail of FIG. 6A reacts to wind;

FIG. 7A is a perspective view of a sail in accordance with one embodiment of the invention;

FIG. 7B is a diagrammatic view of how the sail of FIG. 7A reacts to wind;

FIG. 8A is a perspective view of a sail in accordance with one embodiment of the invention;

FIG. 8B is a diagrammatic view of how the sail of FIG. 8A reacts to wind;

FIG. 9 is a side view of a bobber with fishing line passing through a passage in accordance with one embodiment of the invention;

FIG. 10 is a side view of a bobber with fishing line passing through a passage in accordance with one embodiment of the invention;

FIG. 11 is a side view of a bobber with fishing line attached in accordance with one embodiment of the invention;

FIG. 12A is a perspective view of a bobber in accordance with one embodiment of the invention;

FIG. 12B is a cross sectional view of a bobber in accordance with one embodiment of the invention; and

FIG. 13 is a cross sectional view of a bobber in accordance with one embodiment of the invention.

### DETAILED DESCRIPTION OF THE INVENTION

The invention is a bobber that includes a float and sail. The sail catches the wind and stealthily moves the bait over to the area where the fish are, such as under the overhanging trees or branches near the shore of a lake. The sail also makes the bobber more aerodynamic and allows for more accurate casting. The sail may be attached to a stem that is attached to the float. The sail may be removable from the stem. This allows the fisherman to put on larger or smaller sails and also directional sails. The stem and/or the float may have a passage way so that the bobber can be used a slip bobber or a fixed bobber.

FIG. 1 is a diagram of a fisherman 12 using a bobber 14 in accordance with one embodiment of the invention. The fisherman 12 has the wind 16 at his back. The fisherman 12 casts his line 18 so that the bobber 14 initial contact point 20 is before the overhanging tree 22. The wind then stealthily pushes the bobber 14 and associated bait 24 under the overhanging tree 22 to a point where fish 26 congregate. As a result, the bobber 14 does not scare the fish when it is cast because the initial point 20 is not same as the position of the bobber 14 at a later time. In addition, the bobber 24 can be sailed under overhangs.

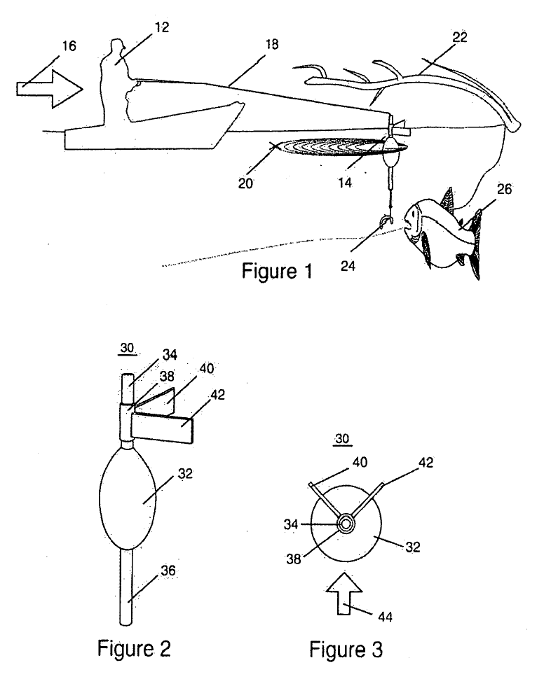

FIG. 2 is a perspective view of a bobber 30 in accordance with one embodiment of the invention. The bobber 30 has a float 32 connected to a top stem 34 and a bottom stem 36. A sail 38 is attached to the top stem 34 and has a pair of wings 40 & 42. Note the top stem 34 and bottom stem 36 may be part of a single cylinder that extends through the float 32. The sail 38 provides a more aerodynamic stable float the travels true through the air and increases the accuracy of casts.

FIG. 3 is a top view of a bobber 30 in accordance with one embodiment of the invention. The bobber 30 has a sail 38 attached to the step 34. The sail has two wings 40 & 42. An arrow shows the direction of the wind 44 and how the bobber will orient it self to the wind 44. The bobber 30 will sail in the direction the wind 44 is blowing.

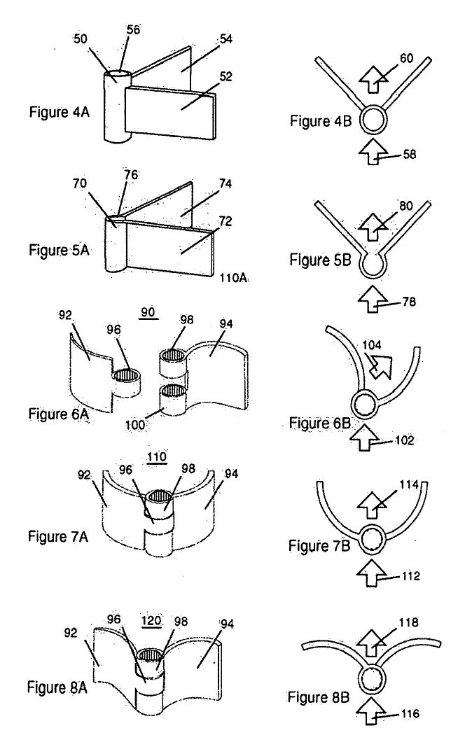

FIG. 4A is a perspective view of a sail 50 in accordance with one embodiment of the invention. The sail 50 has a pair of V-shaped wings 52 & 54. note that the sail 50 has a slot 56 that fits over a stem for attachment.

FIG. 4B is a diagrammatic view of how the sail 50 of FIG. 4A reacts to wind 58. The bobber 50 will move in the direction of arrow 60.

FIG. 5A is a perspective view of a sail 70 in accordance with one embodiment of the invention. The sail 70 has a pair of V-shaped wings 72 & 74. note that the sail 70 has an open slot 76 that clips over a stem for attachment.

FIG. 5B is a diagrammatic view of how the sail 70 of FIG. 5A reacts to wind 78. The bobber 70 will move in the direction of arrow 80.

FIG. 6A is a perspective view of a sail 90 in accordance with one embodiment of the invention. The sail 90 has a pair of wings 92 & 94. The pair of wings have curvature that is not flat. The wing 92 has a slot 96 that fits over a stem for attachment. The wing 94 has a pair of slots 98 & 100 that encompass the slot 96 of wing 92.

FIG. 6B is a diagrammatic view of how the sail 90 of FIG. 6A reacts to wind 102. The bobber 90 will move in the direction of arrow 104. Note that this sail 90 design allows the bobber 90 to sail at an angle to the wind.

FIG. 7A is a perspective view of a sail 110 in accordance with one embodiment of the invention. The sail 110 has a pair of wings 92 & 94 with the same shape as that shown in FIG. 6A however wing 94 is flipped.

FIG. 7B is a diagrammatic view of how the sail 110 of FIG. 7A reacts to wind 112. The bobber 110 will move in the direction of arrow 114.

FIG. 8A is a perspective view of a sail 120 in accordance with one embodiment of the invention. The sail 120 has a pair of wings 92 & 94 with the same shape as that shown in FIG. 6A however wing 92 is flipped.

FIG. 8B is a diagrammatic view of how the sail 120 of FIG. 8A reacts to wind 116. The bobber 120 will move in the direction of arrow 118.

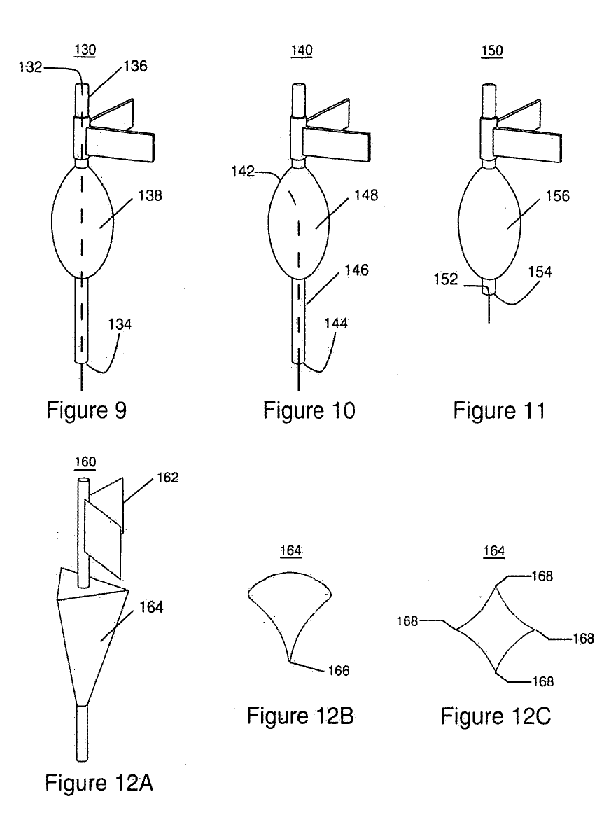

FIG. 9 is a side view of a bobber 130 with fishing line 132 passing through a passage 134 in accordance with one embodiment of the invention. In this example the passage extends through the stem 136 and the float 138. This allows the float to be used as a slip bobber.

FIG. 10 is a side view of a bobber 140 with fishing line 142 passing through a passage 144 in accordance with one embodiment of the invention. In this example the passage extends through the bottom stem 146 and the float 148. This allows the float to be used as a slip bobber.

FIG. 11 is a side view of a bobber 150 with fishing line 152 attached in accordance with one embodiment of the invention. In this case the line 152 is attached to an attachment point 154 at the bottom of the float 156.

FIG. 12A is a perspective view of a bobber 160 in accordance with one embodiment of the invention. This bobber 160 has a float 162 and sail 164. However, in this case the float has keel shape, which can best be seen in FIGS. 12B & 12C. FIGS. 12B & C show two alternative embodiments of the keel shaped float 164. The float in FIG. 12B has a single keel shape 166, while the float of FIG. 12C has four keep shapes 168. The keel shape allows the bobber 160 to sail more efficiently through the water and is therefore good for light wind conditions.

Thus there has been described a bobber that is more aerodynamic and does not scare away the fish.

While the invention has been described in conjunction with specific embodiments thereof, it is evident that many alterations, modifications, and variations will be apparent to those skilled in the art in light of the foregoing description. Accordingly, it is intended to embrace all such alterations, modifications, and variations in the appended claims.

What is claimed is:

1. A bobber, comprising:
a float,
a stem extending from the float; and
a sail attached to the stem.

2. The bobber of claim 1, wherein the sail has a V-shaped cross section.

3. The bobber of claim 1, wherein the sail has a first wing and a second wing.

4. The bobber of claim 3, wherein the first wing has a curvature.

5. The bobber of claim 1, wherein the float has a keel shape.

6. The bobber of claim 1, wherein the stem is hollow.

7. A bobber, comprising:
a float; and
a sail connected to the float.

8. The bobber of claim 7 wherein the float has a keel.

9. The bobber of claim 7, wherein the sail a first wing and a second wing.

10. The bobber of claim 10, wherein the second wing has a curvature.

11. The bobber of claim 7, wherein the float has a passage through the float.

12. The bobber of claim 7, wherein the sail is detachable from the float.
